(19) United States
(12) Patent Application Publication
(10) Pub. No.: US 2011/0017479 A1
(43) Pub. Date: Jan. 27, 2011

(54) METHOD OF EXTINGUISHING A FIRE AND THE EXTINGUISHER

(76) Inventor: Koushi KARIYA, Tokyo (JP)

Correspondence Address: BERENATO & WHITE, LLC, 6550 ROCK SPRING DRIVE, SUITE 240, BETHESDA, MD, 20817, US

(21) Appl. No.: 12/507,547

(22) Filed: Jul. 22, 2009

(51) Int. Cl. A62C 2/00

(52) U.S. Cl. 169/46; 169/65

(57) ABSTRACT

The purpose of the present invention is to provide the method of preventing the expansion at a minimum and extinguishing oil fire easily and to provide an extinguisher. The method of extinguishing oil fire which occurs in cooking equipment for household use or for business use is to spray extinguishing agent to firing cooking equipment as consecutive liquid drops at the flow rate from 20 ml/min to 1200 ml/min per one excretory pore at the height from 0 cm to 300 cm.

### BACKGROUND OF THE INVENTION

1. Technical Field

The present invention relates to the method of extinguishing an oil fire and the extinguisher. Specifically, the invention relates to the inexpensive method of extinguishing quickly and reliably an oil fire, such as tempura fire, fryer fire and the extinguisher.

2. Background Art

It is said that an oil fire which occurs when cooking oil is heated occurs because of heating oil up to a firing point. For example, the firing point of oil for tempura is from 360° C. to 400° C.

The methods of extinguishing oil fire such as oil for tempura are as follows;
(1) The method of extinguishing by suffocating with cover.
(2) The method of extinguishing with powder extinguisher.
(3) The method of extinguishing with liquid extinguisher.
(4) The method of extinguishing with aerosol extinguisher.

The method of extinguishing by suffocating with cover is conducted by covering a whole pan with wet bath towel or sheet after they are squeezed lightly. There is a possibility that a user overturns a pan in a panic. This method cannot be used when a fire becomes large.

The method of extinguishing with powder extinguisher is conducted with commercially available extinguisher. When we stop spraying extinguishing agent after we extinguish fire, a fire reignites. Therefore, we need to spray all amount of extinguishing agent into oil. There is a possibility that we lose sight of fire with extinguishing agent.

The method of extinguishing with liquid extinguisher is more effective than powder extinguisher, because we can extinguish not only fire in a pan but also splattered oil. However, a liquid extinguisher with a spray nozzle has a demerit of polluting surrounding area with splattered oil. Furthermore, there is a possibility that we expand fire with wind pressure and splattered oil.

The method of extinguishing with aerosol extinguisher of inert gas such as carbon dioxide gas is easy to use and effective. An aerosol extinguisher has a demerit of being very expensive in the case of using only an aerosol extinguisher. Therefore, in actual, an aerosol extinguisher is used for only small-scale oil fire.

In the patent reference H07-24080 and the patent reference 2004-321272, the method of spraying carbon dioxide gas and liquid extinguishing agent at the same time is described.

### SUMMARY OF INVENTION

However, because in these methods of extinguishing fire, liquid extinguishing agent and carbon dioxide gas are sprayed at the same time, there is a problem of expanding fire by splattered oil.

Therefore, an object of the invention is to provide the method of extinguishing fire easily with preventing fire from expanding by splattered oil at a minimum.

Another object of the invention is to provide an extinguisher which can extinguish fire easily with preventing fire from expanding by splattered oil at a minimum.

The present invention to resolve the above-mentioned problem is the method of extinguishing oil fire which occurs from cooking equipment for household use or business use when cooking oil is overheated. The invention is the method of extinguishing oil fire which drops extinguishing agent to firing cooking equipment at the flow rate from 20 ml/min to 1200 ml/min per one pore as consecutive liquid drops from more than one spraying excretory pore at the height of from 0 cm to 300 cm until the fire is extinguished.

Consecutive drop of extinguishing agent means dropping consecutive liquid drops of extinguishing agent to the surface of heated oil in firing cooking equipment. That is not mist but consecutive liquid drops at predetermined flow rate from more than one relatively large spraying excretory pore. It is possible to extinguish oil fire easily with dropping extinguishing agent at predetermined flow rate evenly to heated oil in the firing cooking equipment and without splattered oil including firing oil. Little flame rises by wind pressure.

The method of extinguishing oil fire of the present invention can use properly extinguishing agent of main component of aqueous solution of potassium carbonate from 20 to 50% by weight.

The present invention to resolve the aforesaid problem is an extinguisher which conducts the method of extinguishing oil fire and is composed of a nozzle for spraying with more than one excretory pore, a tank combined with the nozzle for spraying through flow channel, and a means for spraying extinguishing agent in the tank at predetermined flow rate. The means for spraying extinguishing agent is controlled to be sprayed as liquid drops at predetermined flow rate of the range from 20 ml/min to 1200 ml/min per one pore of the nozzle.

In the extinguisher of the present invention, the means for spraying extinguishing agent is preferably composed of a motor driven by battery and a pump spraying extinguishing agent with motor.

The nozzle of the extinguisher of the present invention has preferably from 2 to 50 excretory pores of the effective area from 0.1 mm² to 50 mm².

The nozzle of the extinguisher of the present invention is preferably from 5 cm to 200 cm long.

The extinguisher of the present invention can be composed of supporting part which installs a nozzle at the end of cooking equipment or on the table of cooking equipment and dropping part of extension of the supporting part at predetermined height from cooking equipment.

The extinguisher of the present invention can be composed of a tank for extinguishing agent in accordance with oil amount of cooking equipment.

The extinguishing agent for the present invention is not restricted if it is the one adaptable for cooking oil. For example, the extinguishing agent of main ingredient of aqueous solution of potassium carbonate from 20 to 50% by weight is the most preferable.

Dropping extinguishing agent in the present invention means dropping liquid drops of extinguishing agent to firing cooking equipment and is different from mist, shower and strong flow. It is possible to extinguish easily oil fire without splattered heated oil including firing oil by dropping liquid drops at predetermined flow rate to heated oil in firing cooking equipment.

The extinguisher of the present invention is not restricted if it is a motor which can drop extinguishing agent at predetermined flow rate and uses motor driven by battery preferably. Using battery including rechargeable battery makes the extinguisher more mobile.

The nozzle is not restricted if it is a shape of ability to drop predetermined amount of extinguishing agent and has shape of ability to drop liquid drops from more than two excretory pores of a nozzle. The shape of excretory pores is not restricted and can be circle, oval and polygon. The dropping part of a nozzle has from 2 to 20 excretory pores of the effective area from 1 mm² to 1.5 mm².

The length of a nozzle of the present invention is not restricted and is preferable length of enough distance from fire to a user. Specifically, the nozzle is from 5 cm and 150 cm.

The extinguisher of the present invention can be composed of supporting part which installs a nozzle at the end of cooking equipment or on the table of cooking equipment and dropping part of extension of the supporting part at predetermined height from cooking equipment.

The extinguisher of the present invention can be composed of a tank for extinguishing agent in accordance with oil amount of cooking equipment to provide the extinguisher by using all amount of extinguishing agent.

The method of extinguishing oil fire of the present invention can extinguish oil fire easily by dropping at predetermined flow rate evenly to heated oil in the firing cooking equipment and without splattering heated oil including firing oil. The method of extinguishing oil fire of the present invention can extinguish oil fire without rising flame by wind pressure because it does not spray air.

The extinguisher of the present invention can extinguish without splattering oil by dropping consecutive liquid drops from more than one excretory pore at predetermined flow rate to the cooking equipment for household use or business use. The extinguisher of the present invention can extinguish oil fire without rising flame by wind pressure because it does not spray air.

### BRIEF DESCRIPTION OF DRAWINGS

FIG. 1 shows one embodiment of extinguisher of the present invention.

FIGS. 2A and 2B show examples of the shape of a nozzle of the present invention.

### DESCRIPTION OF PREFERRED EMBODIMENTS

We explain preferred embodiment of the present invention by referring attached figures as follows;

In the present invention, the phrase “oil fire which occurs from cooking equipment for household use or business use when cooking oil is overheated” generally means a fire igniting by overheating when a user cooks by heating oil including tempura fire and fryer fire. The present invention targets such a fire.

In the present invention, an oil fire is extinguished by the extinguishing agent well-known in this technical field (generally liquid extinguishing agent), and the extinguishing agent is not restricted if it is one attaining the purpose of the present invention. Aqueous solution of main component of potassium carbonate, especially aqueous solution from 20 to 50% by weight, is used preferably in terms of preservation stability and cost.

Oil is not restricted if it is a cooking oil. Such oil ignites at the temperature from 300° C. to 400° C.

The inventors invent the present invention by finding the ability to extinguish easily without splattering heated oil including firing oil and without raising flame high by wind pressure by using this extinguishing agent to heated oil in the cooking equipment in which oil fire occurs.

When the extinguishing agent is used to oil fire, it was found that this extinguishing agent is extinguishable without splattering oil and raising high flame as follows;
(1) Using the extinguishing agent as consecutive liquid drops sprayed out from more than one excretory pore (preferably more than two excretory pores).
(2) Spray in predetermined range of flow rate.
(3) Keeping a distance from the surface of oil in the firing cooking equipment.

The first condition of the method of extinguishing oil fire of the present invention is that the extinguishing agent is used as consecutive liquid drops from more than one excretory pore of spraying nozzle for the oil surface in the firing cooking equipment.

If the extinguishing agent is sprayed with mist or thin shower, it cannot extinguish enough because of strong flame. In this case, the extinguishing agent cannot extinguish enough because it evaporates before it reaches the liquid surface.

The extinguishing agent from one excretory pore reaches at the more flow rate than from over two excretory pores. Therefore, in this case, it raises flame highly. Because the extinguishing agent which is higher specific gravity than oil goes under oil, it cannot extinguish enough. Therefore, multiple excretory pores are preferable.

The second condition of the method of extinguishing oil fire of the present invention is that the range of flow rate of extinguishing agent is set from 20 ml/min to 1200 ml/min per one excretory pore. If the flow rate per one excretory pore is less than 20 ml/min, the extinguishing agent cannot extinguish enough because of strong flame. In this case, the extinguishing agent cannot extinguish enough because it evaporates before it reaches the liquid surface.

If the flow rate per one excretory pore is more than 1200 ml/min, it raises flame highly or because the extinguishing agent goes under oil, it cannot extinguish enough.

The preferable flow rate per one excretory pore is from 50 ml/min to 1000 ml/min, more preferable from 60 ml/min to 900 ml/min. These flow rates are determined by the results of the repeated extinguishing experiments by inventors. The extinguishing agent can extinguish oil fire without splattering oil by determining more than one consecutive liquid drops and their flow rate.

The last condition of the method of extinguishing oil fire of the present invention is distance between liquid surface of firing oil and a nozzle. We determine from 0 cm to less than 300 cm. If the height from the liquid surface is minus (the nozzle is into oil), the extinguishing agent cannot extinguish fire. If the extinguishing agent is used from the height of more than 300 cm, the extinguishing agent cannot extinguish fire enough because the extinguishing agent cannot be sprayed on fire stably.

As explained above, according to the method of extinguishing oil fire of the present invention, when the conditions for using the extinguisher is within predetermined condition, the extinguisher can extinguish oil fire without splattering oil. Further because this extinguisher dose not spray on heated oil directly, different from the method of spraying carbon dioxide gas and liquid extinguishing agent described in the patent reference 1 and the patent reference 2, the possibility of splattering oil becomes low.

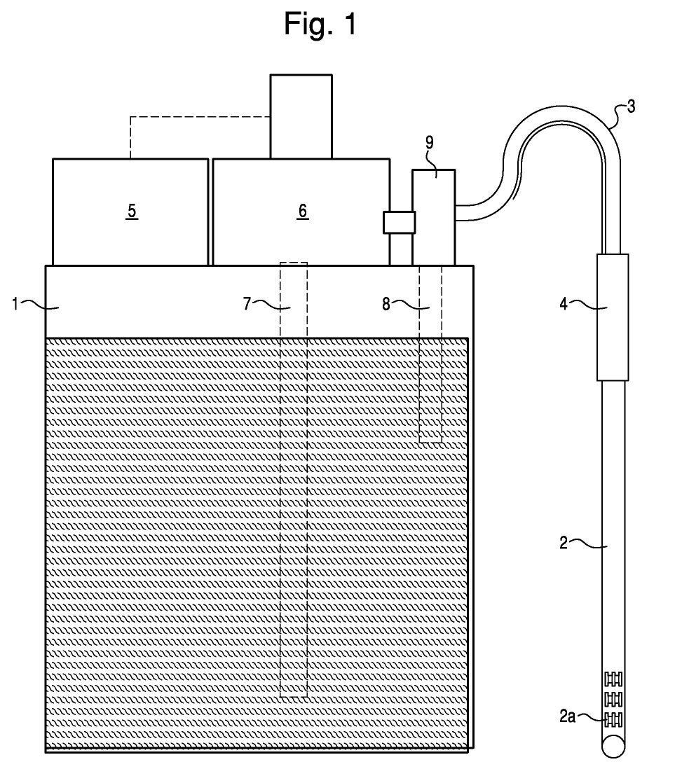

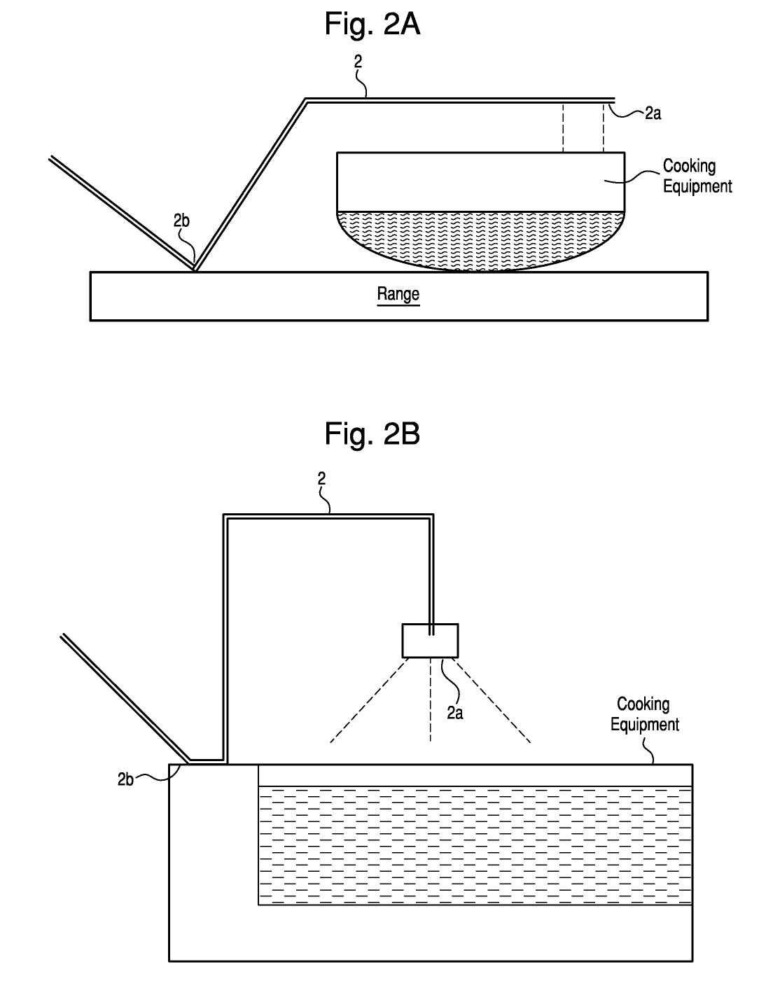

Next, the extinguisher of the present invention will be explained using FIG. 1 and FIG. 2.

FIG. 1 illustrates one embodiment of the extinguisher of the present invention. FIGS. 2A and 2B illustrate one embodiment of a nozzle of the extinguisher of the present invention.

As being illustrated in FIG. 1, the extinguisher of the present invention is composed of a tank 1 for extinguishing agent, a nozzle 2 with more than one excretory pore having the effective area at the end, a joint hose 3 sending the extinguishing agent to the nozzle 2, a handle 4 for holding, a motor 5 of spraying out the extinguishing agent from tank at predetermined flow rate, a pump 6 driven by the motor 5, flow channel 7 for bringing the extinguishing agent into the pump 6, flow channel 8 for reverse the extinguishing agent in the case of bringing the extinguishing agent more than predetermined flow rate, and safety valve 9. The motor always rotates at the number of rotation to spray at predetermined flow rate in FIG. 1. However, the extinguisher can have the control box and knob for controlling flow rate to make flow rate variable.

The extinguisher has a shape (effective area) and a number of excretory pores 2a in a nozzle 2 to spray the extinguishing agent to oil fire directly and is used as the consecutive liquid drops of the extinguishing agent at the flow rate.

The effective area of excretory pores 2a should be from 0.1 mm² to 50 mm², preferably from 0.3 mm² to 30 mm², more preferably from 0.5 mm² to 20 mm². A number of excretory pores 2a should be from 2 to 50 in accordance with the effective area, preferably from 3 to 20.

The extinguishing agent is sprayed out as consecutive liquid drops from excretory pores at predetermined flow rate. The extinguishing agent from excretory pores 2a of a nozzle 2 does not evaporate before reaching the surface oil and does not go under oil.

The amount of the extinguishing agent in the tank may be made by supposing the amount of oil in cooking equipment. Towards oil fire representing tempura fire in an ordinal family, compact and inexpensive extinguisher can be provided by making the amount be in accordance with extinguishing one fire of cooking equipment. When the size of the extinguisher is compact because the weight can be held by one hand, a nozzle can be connected with the tank directly.

The length of a nozzle should be from 5 cm (for household) to 200 cm (for business), to make enough distance from oil of cooking equipment to a user.

As illustrated in FIGS. 2A and 2B, a supporting part 2b which supports a part of a nozzle is installed on the flat area of a range or a cooking table or on the flat area of the end of the cooking equipment. Therefore, the nozzle can be extended at predetermined height from the supporting part 2b. A user can extinguish at the fixed height by fixing a nozzle with the supporting part 2b close to fire and by moving it horizontally as an axis of the supporting part 2b.

### Experiment 1: Effect of Extinguishing Oil Fire by a Nozzle

Experimental oil fire was set by heating 1 litter and 10 litter at 40° C. in a pan for tempura and in a business use fryer. Fire was extinguished with aqueous solution of calcium carbonate of 30% by weight with a nozzle at the flow rate of 6500 cc/min. It was evaluated in three classes. o means extinguished perfectly. □ means extinguished partially. × means no extinguished. The results are in Table 1.

TABLE 1

| | Effective area | Number of | |
|---|---|---|---|
| | of excretory | excretory | Result of |
| No. | pores | pores | extinguish |
| 1-1 | 0.03 | 100 | x |
| 1-2 | 0.05 | 80 | x |
| 1-3 | 0.1 | 60 | □ |
| 1-4 | 0.1 | 40 | ∘ |
| 1-5 | 0.1 | 20 | ∘ |
| 1-6 | 0.5 | 30 | ∘ |
| 1-7 | 0.8 | 30 | ∘ |
| 1-8 | 3 | 20 | ∘ |
| 1-9 | 10 | 7 | ∘ |
| 1-10 | 30 | 5 | ∘ |
| 1-11 | 50 | 1 | x |
| 1-12 | 50 | 3 | ∘ |
| 1-13 | 60 | 2 | ∘ |
| 1-14 | 60 | 1 | ∘ |

The Table 1 shows that even if the flow rate is same, the results are different in relation to the effective area and the number of excretory pores.

### Experiment 2: Extinguishing Experiments by Different Flow Rate

The same experiments as the experiment 1 are conducted using the nozzle of No. 1-7, No. 1-8 and No. 1-10 of the experiment 1 at the flow rates shown in Table 2. The results are shown in Table 2.

| | | | Result of |
|---|---|---|---|
| No. | Nozzle | Flow rate | extinguish |
| 2-1 | 1-7 | 400 | x |
| 2-2 | | 500 | ∘ |
| 2-3 | | 600 | ∘ |
| 2-4 | | 700 | ∘ |
| 2-5 | | 800 | ∘ |
| 2-6 | | 1000 | ∘ |
| 2-7 | | 1300 | □ |
| 2-8 | 1-8 | 400 | x |
| 2-9 | | 500 | ∘ |
| 2-10 | | 600 | ∘ |
| 2-11 | | 700 | ∘ |
| 2-12 | | 800 | ∘ |
| 2-13 | | 1000 | ∘ |
| 2-14 | | 1300 | x |
| 2-15 | 1-10 | 400 | x |
| 2-16 | | 500 | ∘ |
| 2-17 | | 600 | ∘ |
| 2-18 | | 700 | ∘ |
| 2-19 | | 800 | ∘ |
| 2-20 | | 1000 | ∘ |
| 2-21 | | 1300 | x |

In Table 2, the unit of flow rate is cc/min. If the flow rate is within the range of the present invention, the extinguisher can extinguish oil fire effectively. At the flow rate of 400 cc/min, the ability to extinguish is not enough and the extinguisher cannot extinguish oil fire perfectly. At the flow rate of 1300 cc/min, because flame blows high, the extinguisher cannot extinguish oil fire enough.
1 Tank of extinguishing agent
2 Nozzle
2a Excretory pores
2b Supporting part
3 Hose
4 Handle
5 Motor
6 Pump
7 Flow channel
8 Flow channel
9 Safety valve

1. An extinguisher for extinguishing oil fire occurring in house hold use or business use cooking equipment due to overheating of cooking oil, said extinguisher comprising:
a nozzle having two to fifty excretory pores from which an extinguishing agent is to be discharged and each of which has an effective area of 0.1 mm² to 50 mm², the nozzle being positioned above a surface of the cooking oil and away from the surface by 0 cm to 300 cm;
a tank for containing the extinguishing agent, the tank have a flow channel connected to the nozzle; and
extinguishing agent exhausting means for exhausting the extinguishing agent from the excretory pores, the extinguishing agent exhausting means regulating a flow rate of the extinguishing agent at 500 ml/min to 1200 ml/min.

2. The extinguisher according to claim 1, wherein the extinguishing agent comprises a water solution containing 20% to 50% by weight of potassium carbonate as a main component.

3. (canceled)

4. The extinguisher according to claim 1, wherein the extinguishing agent exhausting means comprises a motor which is driven by a battery and a pump which exhausts the extinguishing agent by the motor.

5. The extinguisher according to claim 1, wherein the effective area of each of the excretory pores formed on the nozzle is 0.5 mm²to 20 mm².

6. The extinguisher according to claim 1, wherein the nozzle has a length of 5 cm to 200 cm.

7. The extinguisher according to claim 1, wherein the nozzle comprises a supporting part which is to be provided at one end of the cooking equipment or a table of the cooking equipment, and a dropping part which is to be positioned above the cooking equipment by a predetermined distance while extending from the support part.

8. The extinguisher according to claim 1, wherein the tank has a capacity in accordance with an amount of the cooking oil in the cooking equipment.

9. The extinguisher according to claim 1, wherein the number of excretory pores formed on the nozzle is 3 to 20.

10. The extinguisher according to claim 2, wherein the effective area of each of the excretory pores formed on the nozzle is 0.5 mm² to 20 mm².

11. The extinguisher according to claim 10, wherein the number of excretory pores formed on the nozzle is 3 to 20.

12. The extinguisher according to claim 11, wherein the extinguishing agent exhausting means comprises a motor which is driven by a battery and a pump which exhausts the extinguishing agent by the motor.

13. The extinguisher according to claim 12, wherein the nozzle has a length of 5 cm to 200 cm.

14. The extinguisher according to claim 13, wherein the nozzle comprises a supporting part which is to be provided at one end of the cooking equipment or a table of the cooking equipment, and a dropping part which is to be positioned above the cooking equipment by a predetermined distance while extending from the support part.

15. The extinguisher according to claim 14, wherein the tank has a capacity in accordance with an amount of the cooking oil in the cooking equipment.
